(19) United States
(12) Patent Application Publication
(10) Pub. No.: US 2007/0025332 A1
(43) Pub. Date: Feb. 1, 2007

(54) Collocated router and VoIP

(75) Inventor: Lars Adolfsson, Tyreso (SE)

Correspondence Address: NIXON & VANDERHYE, PC, 901 NORTH GLEBE ROAD, 11TH FLOOR, ARLINGTON, VA, 22203, US

(73) Assignee: B2 BREDBAND AB, Stockholm (SE)

(21) Appl. No.: 11/178,594

(22) Filed: Jul. 12, 2005

(30) Foreign Application Priority Data
Jul. 7, 2005 (SE) 0501591-2

(51) Int. Cl. H04L 12/66

(52) U.S. Cl. 370/352

(57) ABSTRACT

The invention relates to a system and method regarding a switch or router (22) in a broadband network standard such as the Ethernet network standard. The switch or router (22) comprises an interface to for instance a category 3 or 5 infrastructure (12, 16) for distribution of data to flats and offices in premises. Whereby, a category infrastructure comprises four twisted wire pairs connected to every flat and office. Two pairs are utilized by the Ethernet standard. According to the invention a voice over Internet protocol box circuitry is collocated in said switch or router (22) hardware, serving every flat and office with telephony, and an interface (14, 18, 24) to the voice over Internet protocol box circuitry utilizes two of the wire pairs to provide two voice over Internet protocol subscription possibilities to every flat and office.

### TECHNICAL FIELD

The present invention pertains to a reuse of a network infrastructure dedicated for Internet Service such that additional telephony services may be provided over the same infrastructure. Herewith, it regards a switch or router in a broadband network standard, having an interface to a category infrastructure for distribution of data to households/flats/offices in premises. The category infrastructure delivers four twisted wire pairs to every household, whereby two pairs are utilized by the broadband standard.

### BACKGROUND

Currently, a customer that is provided Voice over IP (VolP) is given a VolP Box (CPE, Customer Premises Equipment). The CPE has to be placed in customer's homes, which has several negative implications by customer support calls being increased due to the problem of the customer handling the CPE in a wrong manner, e.g., erroneous cabling etc. Such a solution is also expensive since each customer needs dedicated resources in terms of electronic equipment such as for instance CPU and DSP units.

### SUMMARY OF THE INVENTION

The present invention aims to solve problems when a customer is provided Voice over IP (VoIP). Such problems relate to avoiding for instance erroneous cabling, and that it is expensive since each customer needs dedicated resources in terms of electronic equipment. Hence, the present invention sets forth a switch or router in an Ethernet network standard. The switch or router comprises:

an interface to a category infrastructure for distribution of data to households/flats/offices in premises, comprising four twisted wire pairs to every household, whereby two pairs are utilized by the Ethernet standard;

a voice over Internet protocol box circuitry collocated in the switch or router hardware, serving every household; and

an interface to the voice over Internet protocol box circuitry utilizing two of the wire pairs to provide two voice over Internet protocol subscription possibilities to every household.

In one embodiment the present invention interfaces an RJ-45 outlet and a plug, at least one mounted in every household, the plug having an RJ-45 connector fitting the outlet, and a cabling connecting a unit with three female connectors to mimic a PC RJ-45 outlet and two VolP RJ-11 outlets. Another embodiment comprises that the plug is manufactured such that it connects firm to the RJ-45 outlet.

Yet another embodiment comprises that the voice over Internet control box circuitry has one circuitry connected to every port to a patch panel.

A still further embodiment comprises that the voice over Internet control box circuitry is limited to a specific number below the number of ports connected to a patch panel by estimation of the total number of flats and offices, which simultaneously are making calls.

Furthermore, the present invention sets forth a method provided by a switch or router in an Ethernet network standard. The method comprises the steps of:

interfacing a category infrastructure for distribution of data to households/flats/offices in premises, comprising four twisted wire pairs to every household, whereby two pairs are utilized by the Ethernet standard;

collocating a voice over Internet protocol box circuitry in the switch or router hardware, serving every household; and

interfacing the voice over Internet protocol box circuitry utilizing two of the wire pairs to provide two voice over Internet protocol subscription possibilities to every household.

The present inventions dependent system claims are also pending for the method claims in accordance with the attached set of claims.

### BRIEF DESCRIPTION OF THE DRAWINGS

Henceforth reference is had to the accompanying set of drawings for a better understanding of the present invention with its embodiments and given examples, wherein:

FIG. 1 schematically illustrates a prior art switch/router with an attached VolP box;

FIG. 2 schematically illustrates a prior art RJ-45 outlet utilized to connect Ethernet and telephony traffic;

FIG. 3 schematically illustrates a switch/router comprising VolP circuitry in accordance with the present invention; and

FIG. 4 schematically illustrates a plug in accordance with the present invention which wiring mimics the prior art VolP outlet.

### DETAILED DESCRIPTION OF PREFERRED EMBODIMENTS

Currently, a customer that is provided VolP (Voice over the Internet Protocol) relies on the solution depicted in FIG. 1. FIG. 1 schematically illustrates a prior art switch/router 10 with an attached VolP box 20. The router 10 is frequently situated in a basement of premises and connected by a CAT 3 or 5 (CAT; Category) wiring 12 to a patch panel 14. A patch panel 14 is utilized to distribute the CAT infrastructure to each and every household in premises. It is appreciated that a household should be interpreted as a flat where people are living or an office where they are working and any other suitable space for broadband technology in a premise.

A CAT 3 infrastructure manages transmission speeds of 30 Mbps and a CAT 5 should manage speeds up to 100 Mbps.

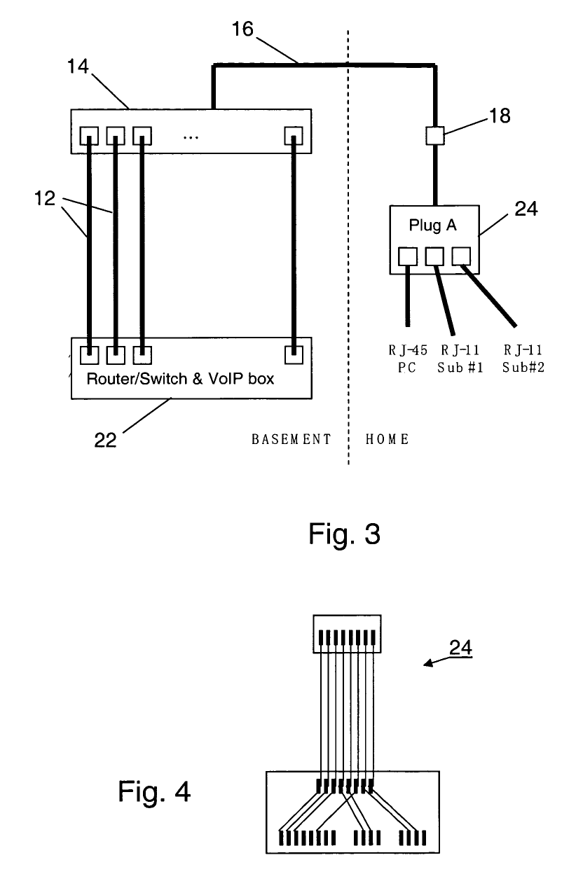

The left side of FIG. 1 illustrates the basement, where equipment is typically located in premises, thus where the active Internet equipment switch or router is situated. The Internet equipment is connected to a backbone network (not shown) and to a patch panel 14. The patch panel is connected to every registered jack outlet (RJ-45) in the different households, one shown to the right in the FIG. 1, and the infrastructure is in one embodiment typically provided by a CAT-5 network wiring 16 to the households. The dashed line in FIG. 1, also in FIG. 3, schematically indicates a boarder between a household and a basement in a premise.

In a home, the VolP Box or CPE 20 (CPE; Customer Premises Equipment) is usually connected directly to a RJ-45 outlet 18. This constellation provides a good quality to VolP traffic. The VolP Box 20 thus is at least equipped with one RJ-45 outlet where a PC or hub/switch could be connected. In addition to this, the VolP Box also typically contains two RJ-11 outlets to support two telephony subscriptions, denoted Sub#1 and Sub#2 in FIG. 1. It is appreciated that FIG. 1 depicts technology regarded as prior art.

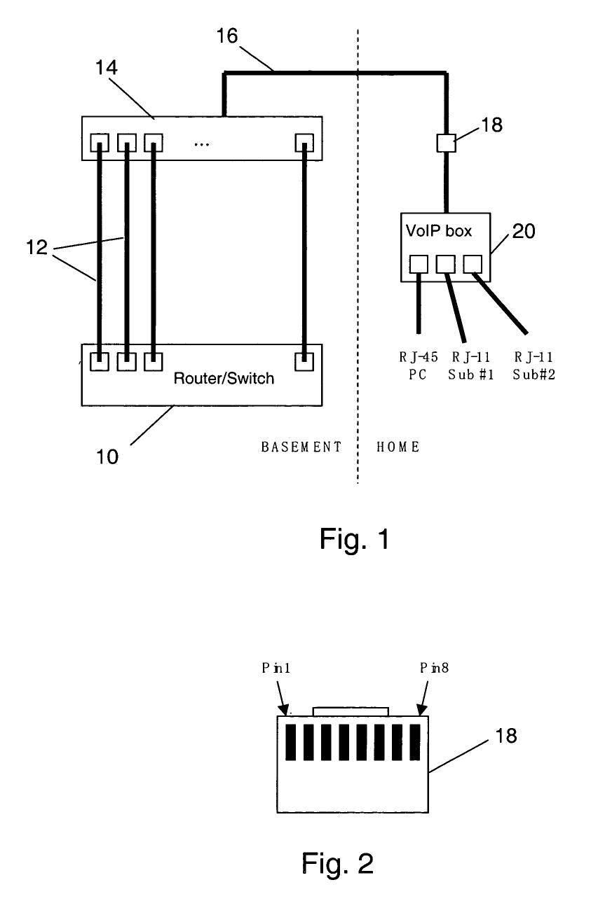

FIG. 2 schematically illustrates a prior art RJ-45 outlet, as mentioned above, utilized to connect Ethernet and telephony traffic. The Pin-out in this embodiment is such that the Internet service utilizes pins 1 and 2 (one pair) and pins 3 and 6 (second pair). The two remaining pairs (4 and 5, 7 and 8) are then utilized to deliver VolP in accordance with prior art.

The present invention is basically based on the notion that a CAT-5 network utilizes four twisted pairs and the Ethernet standard utilizes two of those pairs. This means that the two additional pairs could be utilized to provide two VolP subscriptions. The Ethernet cabling 12, 16 is shown in FIG. 3.

FIG. 3 schematically illustrates a switch/router comprising VolP circuitry in accordance with the present invention. As is depicted in FIG. 3 or schematically indicated is that the Router/Switch 22 is now equipped with the VolP circuitry or comprising it, in contradiction to prior art, which provided VolP into every flat. According to the present invention, in one embodiment every outlet in the Router & VolP could be connected to its own VolP circuitry, which is not very efficient. But with the statistical knowledge of simultaneously ongoing telephony calls, the number of VolP circuitry could be stripped to a suitable number of circuitry shared by every Router outlet according to the statistics. One such statistic or estimation is that one household out of ten simultaneously calls. By accomplishing this it is possible to reduce the number of costly equipment such as CPUs and DSPs (Digital Signal Processors).

Making use of the notion mentioned is allowing the VolP equipment to be situated at a central place in a premise for instance in the basement. This has at least two advantages. Firstly, it is possible to locate all VolP resources to the basement and thus minimizing the amount of electronic equipment, and secondly, the customer is unable to tamper with the VolP equipment which unfortunately often leads to support calls deriving operational costs.

There are mainly two solutions. The first solution is based on the notion that the VolP equipment is collocated in the same hardware as the switch/router, which is schematically depicted in FIG. 1, and making up the basis for the present patent application.

Note that the switch/router 22 in accordance with the present invention now includes the VolP support for all customers and that the Pin-out in the RJ-45 connector is the one described above with reference to FIG. 2, i.e., two pairs are dedicated for VolP subscriptions. To be able to feed the two VolP subscriptions to the actual homes/flats it is necessary to insert a special plug in accordance with the present invention, denoted plug A in FIG. 3 with reference numeral 24. The Plug A wiring is depicted in FIG. 4 and denoted reference numeral 24.

It is to be noted that the RJ-45 male connector is to be inserted into the RJ-45 outlet in the home and the other end consists of a unit with three female connectors to mimic the PC RJ-45 outlet and the twp VolP RJ-11 outlets. The plug can be manufactured such that is connects firm to the RJ-45 outlet.

The second solution to the present invention is based on maintaining the switch/router and utilizing a stand-alone box for the VolP service. But this is described in a co-pending patent application.

The attached set of claims shows other embodiments apparent to a person skilled in the art.

1. A switch or router in a broadband network standard, comprising:
an interface to a category infrastructure for distribution of data to flats and offices in premises, said category infrastructure comprising four twisted wire pairs to every flat and office, whereby two pairs are utilized by said broadband standard;
voice over Internet protocol box circuitry collocated in said switch or router hardware, serving every flat and office; and
an interface to said voice over Internet protocol box circuitry utilizing two of said wire pairs to provide two voice over Internet protocol subscription possibilities to every flat and office.

2. A switch or router according to claim 1, wherein it interfaces an RJ-45 outlet and a plug, at least one mounted in every flat and office, said plug having an RJ-45 connector fitting said outlet, and a cabling connecting a unit with three female connectors to mimic a PC RJ-45 outlet and two VolP RJ-11 outlets.

3. A switch or router according to claim 2, wherein said plug is manufactured such that is connects firm to the RJ-45 outlet.

4. A switch or router according to claim 1, wherein said voice over Internet control box circuitry has one circuitry connected to every out port to a patch panel.

5. A switch or router according to claim 1, wherein said voice over Internet control box circuitry is limited to a specific number below the number of output ports connected to a patch panel by estimation of the total number of flat and offices, which simultaneously are making calls.

6. A method provided by a switch or router in a broadband network standard, comprising the steps of:
interfacing a category infrastructure for distribution of data to flats and offices in premises, comprising four twisted wire pairs to every flat and office, whereby two pairs are utilized by said broadband standard;
collocating voice over Internet protocol box circuitry in said switch or router hardware, serving every flat and office; and
interfacing said voice over Internet protocol box circuitry utilizing two of said wire pairs to provide two voice over Internet protocol subscription possibilities to every flat and office.

7. A method according to claim 6, wherein it interfaces an RJ-45 outlet and a plug, at least one mounted in every flat and office, said plug having an RJ-45 connector fitting said outlet, and a cabling connecting a unit with three female connectors to mimic a PC RJ-45 outlet and two VolP RJ-11 outlets.

8. A method according to claim 6, wherein said plug is manufactured such that is connects firm to the RJ-45 outlet.

9. A method according to claim 6, wherein said voice over Internet control box circuitry has one circuitry connected to every out port to a patch panel.

10. A method according to claim 6, wherein in said voice over Internet control box circuitry is limited to a specific number below the number of output ports connected to a patch panel by estimation of the total number of flat and offices, which simultaneously are making calls.
